(19) United States
(12) Patent Application Publication
(10) Pub. No.: US 2005/0159094 A1
(43) Pub. Date: Jul. 21, 2005

(54) Apparatus and method for cutting meat

(76) Inventor: Steven W. Dunivan, Amarillo, TX (US)

Correspondence Address: David Allen Hall;Suite 2100, 112 E. Pecan Street, San Antonio, TX, 78205, US

(21) Appl. No.: 11/031,860

(22) Filed: Jan. 7, 2005

Related U.S. Application Data
(60) Provisional application No. 60/535,071, filed on Jan. 8, 2004.

(51) Int. Cl. A22B 5/20

(52) U.S. Cl. 452/163

(57) ABSTRACT

Apparatus and method for cutting meat that enables a worker to repeatedly and consistently guide a securely clamped carcass through the cutting area of a saw without exposing his or her hands to the saw's cutting implement. The operator sets a carcass in a set of clamps. Tightening of the clamps, alignment of the carcass with respect to the saw blade, and movement of the clamps and carcass through the cutting area is done with controls located on the apparatus at locations safely remote from the cutting area. Alignment, done with a laser beam, is precise and repeatable. Conveyors built into the apparatus carry the useful and scrap parts of the carcass away for convenient and safe disposal. The hands-free cutting operation minimizes human contact with the meat being cut, thereby enhancing hygiene.

### PRIORITY

This application claims priority from the provisional application No. 60/535,071 filed Jan. 8, 2004.

### FIELD OF THE INVENTION

The present invention pertains to the field of foodstuffs preparation, more particularly the field of cutting meat in preparation for packaging.

### BACKGROUND OF THE INVENTION

In many meat packaging facilities, workers currently cut meat using a band saw, so-named because its cutting apparatus is a toothed or serrated steel band. The band is continuous, typically traverses a loop defined by guide rollers and wheels, and is typically powered by the friction of pinch rollers. A vertical portion of the band is generally exposed where it travels between an opening in the horizontal surface (generally called the table) on which the meat rests and a portion of the saw (generally called the head) that is above the table.

In production, operators set carcasses on the saw table and push them by hand into the moving saw band. The parts of the carcass that are to be packaged and sold, and any waste parts of the carcass are generally moved from the saw area by hand. The entire procedure is fraught with potential for contamination of foodstuffs through transfer of bacteria, and is also fraught with danger to the operators in the form of severe lacerations and amputations.

### SUMMARY OF THE INVENTION

The present invention reduces the potential for unsanitary contact with foodstuffs and the potential for severe injury to workers in the meat cutting industry by disclosing an apparatus and method for cutting meat that enables a worker to repeatedly and consistently guide a securely clamped carcass through the cutting area of a saw without exposing his or her hands to the saw's cutting implement. Movement of the useful and waste parts of the carcass after the cutting operation is accomplished with a minimum or no human hand contact.

### BRIEF DESCRIPTION OF THE DRAWINGS

FIG. 1 is a front elevation of the preferred embodiment of the present invention.

FIG. 2 is a top plan view of the preferred embodiment of the present invention.

### DETAILED DESCRIPTION OF THE INVENTION

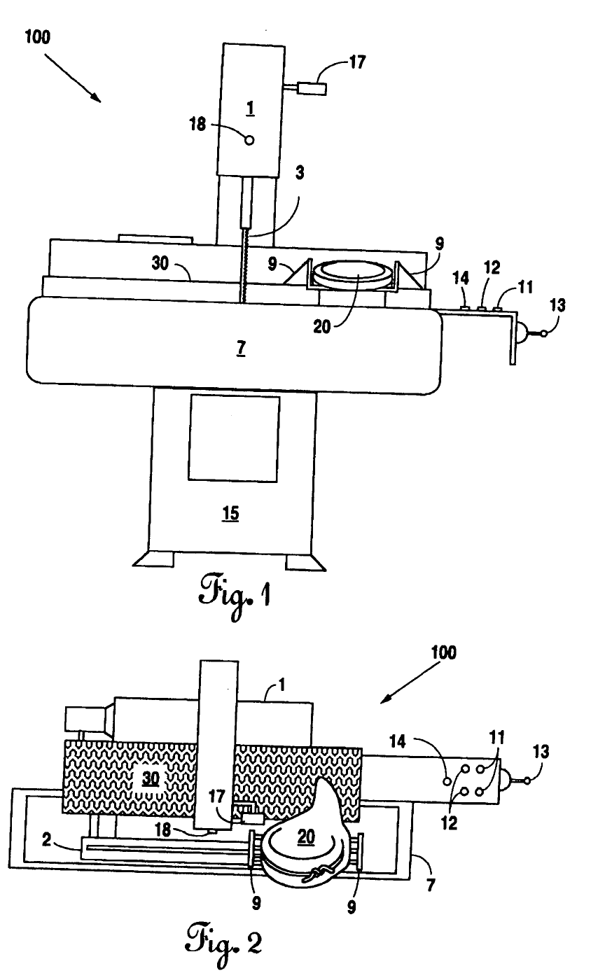

FIGS. 1 and 2 illustrate a preferred embodiment 100 of the apparatus of the present invention. Herein the directions “left,” “right,” “in,” and “out” refer to directions with respect to the plane of the FIG. 1 front elevation drawing as viewed from the front.

The preferred embodiment is a power saw utilizing a motor-powered cutting implement. The saw has a base 15 for supporting the entire apparatus at a convenient working height, a head 1 that partially houses a cutting implement, and a band saw blade 3. Clamps 9 can move left and right and in and out on clamp support 2 built into table 7. Such movements of clamps 9 are accomplished by pistons and cylinders that are activated by generally understood controls such as joy stick 13. In the preferred embodiment such cylinders and joy stick controls are pneumatic.

In operation, a carcass 20 is placed on clamps 9 that are activated by push buttons 11 so as to firmly capture carcass 20. With joy stick 13, an operator moves clamps 9 in and out so as to align the clamped carcass 20 with blade 3 under the guidance of a beam generated by laser unit 17 mounted on head 1. The preferred laser is model LLG-1500 by Seiffert Industrial, Inc.

Clamps 9 are then moved left toward blade 3 by activation of buttons 12. When clamps 9 and carcass 20 have traversed a predetermined distance through the saw's cutting area, and the desired cut is complete, clamps 9 are between blade 3 and the left end of table 7. Carcass 20 is then automatically released by clamps 9, and clamp support 2 tilts so that its right end is above its left end, thereby dropping the carcass onto a conveyor (not shown). Alternatively, with clamps 9 near the left end of table 7, carcass 20 can be released from clamps 9 by activating button 14 and carcass 20 can then be moved by hand to a secondary receptacle, conveyor, or location. Substantially simultaneously the cut-off portion of carcass 20 is conveyed by conveyor 30, mounted on base 15 behind blade 3, to the left end of base 15, and into a receptacle or onto a conveyor (not shown). Clamp support 2 and clamps 9 subsequently return to their original positions, ready to receive another carcass for another cutting cycle.

In the preferred embodiment, buttons 11, 12, and 14 are pneumatic. At any time during a cutting cycle, the operator can shut off all electrical and pneumatic power to the present invention by depressing emergency power-off (EPO) switch 18 that is located in a prominent, easily accessible location such as the front of head 1 at approximate eye-level. EPO switch 18 can also bleed air lines for immediate release of any components such as clamps 9 that are pneumatically powered.

While the present invention has been described in terms of one preferred embodiment, it will be apparent to those skilled in the art that form and detail modifications may be made to those embodiments without departing from the spirit or scope of the invention. For example, the cutting implement could be something other than a band, such as a circular blade. The pistons and cylinders that move clamps 9, as well as buttons 11, 12, and 14 could be mechanical, electrical, or hydraulic, rather than pneumatic. Also, the drive mechanisms could be commonly understood leadscrews or worm gears, or combinations thereof, rather than pistons and cylinders. The object to be cut could also be a material other than meat.

1. A method for cutting meat comprising:
placing a carcass in a clamp, said clamp being capable of moving on a substantially horizontal table member of a power saw, said power saw being capable of cutting meat with a cutting implement;
holding said carcass in said clamp;
moving said clamp so as to bring said carcass into contact with said cutting implement; and
holding said carcass in said clamp and moving said clamp without direct human contact with said carcass during said holding and said movement.

2. The method of claim 1 further comprising moving said clamp in conformance with a reference light beam.

3. The method of claim 1 further comprising moving said clamp in conformance with a reference laser beam.

4. The method of claim 1 further comprising severing a waste portion from said carcass.

5. The method of claim 1 further comprising catching said waste portion immediately after said waste portion is severed from said carcass.

6. The method of claim 1 further comprising releasing said carcass from said clamp after said waste portion has been severed from said carcass and said clamp has moved away from said cutting implement.

7. The method of claim 1 further comprising tilting said clamp so that said carcass is capable of falling from said clamp.

8. The method of claim 1 further comprising catching said carcass immediately after said carcass falls from said clamp.

9. The method of claim 1 wherein the object to be cut is not meat.

10. An apparatus capable of utilizing the method of claim 1, said apparatus comprising:
a substantially horizontal table member;
a substantially vertical head member;
a cutting implement capable of being supported substantially between said table and head members; and
a clamp moveably attached to said table member, said clamp capable of holding a carcass and moving said carcass into contact with said cutting implement, said clamp being capable of moving relative to said cutting implement, said clamp being capable of tilting relative to said table member, and said clamp being capable of releasing said carcass.

11. An apparatus as in claim 10 further comprising a light beam capable of providing reference guidance for alignment of said clamp with said cutting implement.

12. An apparatus as in claim 10 further comprising a laser beam capable of providing reference guidance for alignment of said clamp with said cutting implement.

13. An apparatus as in claim 10 further comprising a conveyor capable of catching a waste portion of said carcass that is severed from said carcass by said cutting implement.

14. An apparatus as in claim 10 further comprising a receptacle capable of catching a waste portion of said carcass that is severed from said carcass by said cutting implement.

15. An apparatus as in claim 10 further comprising a conveyor capable of catching said carcass when said carcass is released from said clamp.

16. An apparatus as in claim 10 further comprising a receptacle capable of catching said carcass when said carcass is released from said clamp.

17. An apparatus as in claim 10 wherein an object to be cut is not meat.

18. A method for cutting meat comprising:
placing a carcass in a clamp, said clamp being capable of moving on a substantially horizontal table member of a power saw, said power saw being capable of cutting meat with a cutting implement;
holding said carcass in said clamp;
moving said clamp so as to bring said carcass into contact with said cutting implement;
holding said carcass in said clamp and moving said clamp without direct human contact with said carcass during said holding and said movement;
moving said clamp in conformance with a reference light beam;
severing a waste portion from said carcass;
catching said waste portion immediately after said waste portion is severed from said carcass;
releasing said carcass from said clamp after said waste portion has been severed from said carcass and said clamp has moved a predetermined distance away from said cutting implement;
tilting said clamp so that said carcass is capable of falling from said clamp; and
catching said carcass immediately after said carcass falls from said clamp.

19. An apparatus capable of utilizing the method of claim 18, said apparatus comprising:
a substantially horizontal table member;
a substantially vertical head member;
a cutting implement capable of being supported substantially between said table and head members;
a clamp moveably attached to said table member, said clamp capable of holding a carcass and moving said carcass into contact with said cutting implement, said clamp being capable of moving relative to said cutting implement, said clamp being capable of tilting relative to said table member, and said clamp being capable of releasing said carcass;
a laser beam capable of providing reference guidance for alignment of said clamp with said cutting implement;
a conveyor capable of catching a waste portion of said carcass that is severed from said carcass by said cutting implement;
a receptacle capable of catching a waste portion of said carcass that is severed from said carcass by said cutting implement;
a conveyor capable of catching said carcass when said carcass is released from said clamp; and
a receptacle capable of catching said carcass when said carcass is released from said clamp.

20. An apparatus as in claim 19 wherein an object to be cut is not meat.
